(19) United States
(12) Patent Application Publication
(10) Pub. No.: US 2011/0080373 A1
(43) Pub. Date: Apr. 7, 2011

(54) Touch Panel and Display Device Using the Same

(75) Inventors: Wen-Chun Wang, Taichung City (TW); Wen-Tui Liao, Taichung City (TW); Ching-Fu Hsu, Fongyuan City (TW); Chih-Chang Lai, Taiping City (TW)

(73) Assignee: WINTEK CORPORATION, Taichun (TW)

(21) Appl. No.: 12/899,364

(22) Filed: Oct. 6, 2010

(30) Foreign Application Priority Data
Oct. 7, 2009 (TW) 98133933
Sep. 15, 2010 (TW) 99131319

(51) Int. Cl. G06F 3/045

(52) U.S. Cl. 345/174

(57) ABSTRACT

A touch panel includes a first substrate, a sensing electrode structure, a second substrate, a soft spacer layer and a shielding layer. The first substrate and the second substrate are parallel to each other, and the soft spacer layer is interposed between the first substrate and the second substrate for maintaining a gap between the first substrate and the second substrate. The sensing electrode structure is disposed on the first substrate for producing a first capacitance between the sensing electrode structure and an exterior object. The shielding layer is disposed on the second substrate, electrically connected to a ground side, and used for producing a second capacitance between the shielding layer and the sensing electrode structure when the exterior object is pressed and causes the gap to vary. The quantity of variation in the first and second capacitances is used for detecting a touch-control action of the exterior object.

This application claims the benefits of Taiwan application Serial No. 98133933, filed Oct. 7, 2009 and Taiwan application Serial No. 99131319, filed Sep. 15, 2010, the subject matter of which is incorporated herein by reference.

### BACKGROUND OF THE INVENTION

1. Field of the Invention

The invention relates in general to a touch panel, and more particularly to a touch panel and a touch display device using the same.

2. Description of the Related Art

From iPhone, Surface to Windows 7, multi-touch has become a new man-machine interface which replaces keyboards and mouse. To realize multi-touch function, touch sensing control, hardware driving and man-machine interface of application programs need to be integrated. Most importantly, a touch panel that meets the related requirements must be provided. Currently, the touch panel covers a wide range of application such as (1) portable consumer electronic and communication products, (2) financial or business use, (3) industrial use, and (4) public information use.

The touch technology, which provides the features of multi-touch, long lifespan, and high penetration, is in great demand and has great potential. The touch panel senses the capacitance change on its surface through the user's finger. However, it is quite a nuisance to those who wear gloves seasonally or habitually to take off gloves before performing a touch-control action.

### SUMMARY OF THE INVENTION

The invention is directed to a touch panel and a touch display device using the same. The touch panel is capable of detecting the touch-control action of a charged or non-charged object. Thus, the touch panel can be operated regardless the user wears a glove or operates with a stylus.

According to a first aspect of the present invention, a touch panel including a first substrate, a second substrate, a sensing electrode structure, a soft spacer layer and a shielding layer is disclosed. The first substrate and the second substrate are parallel to each other, and the soft spacer layer is interposed between the first substrate and the second substrate for maintaining a gap between the first substrate and the second substrate. The sensing electrode structure is disposed on the first substrate for producing a first capacitance between the sensing electrode structure and an exterior object. The shielding layer is disposed on the second substrate, electrically connected to a ground side, and used for producing a second capacitance between the shielding layer and the sensing electrode structure when the exterior object is pressed and causes the gap to vary. The quantity of variation in the first and second capacitances is used for detecting a touch-control action of the exterior object.

According to a second aspect of the present invention, a touch panel including a soft substrate, a sensing electrode structure, a plurality of conductive electrode wires, an insulating protection layer and a shielding layer is disclosed. The soft substrate has a first surface and a second surface opposite to the first surface. The sensing electrode structure is disposed on the first surface for producing a first capacitance between the sensing electrode structure and an exterior object. The conductive electrode wires are disposed on the sensing electrode structure, and are located at edges of the sensing electrode structure. The insulating protection layer covers the conductive electrode wires and the sensing electrode structure. The shielding layer is disposed on the second surface, connected to the ground end, and used for producing a second capacitance between the shielding layer and the sensing electrode structure when the exterior object presses the soft substrate and causes the thickness of the soft substrate to vary. The quantity of variation in the first and second capacitances is used for detecting a touch-control action of the exterior object.

According to a third aspect of the present invention, a touch display device including a first substrate, a second substrate, a third substrate, a sensing electrode structure, a soft spacer layer, a shielding layer and a liquid crystal layer is disclosed. The second substrate and the first substrate are parallel to each other, and the soft spacer layer is interposed between the first substrate and the second substrate for maintaining a gap between the first substrate and the second substrate. The third substrate is parallel to the second substrate and has an active pixel array structure. The liquid crystal layer is interposed between the second substrate and the third substrate.

The sensing electrode structure is disposed on the first substrate for producing a first capacitance between the sensing electrode structure and an exterior object. The shielding layer is disposed on the second substrate, electrically connected to a ground side, and used for producing a second capacitance between the shielding layer and the sensing electrode structure when the exterior object is pressed and causes the gap to vary. The quantity of variation in the first and second capacitances is used for detecting a touch-control action of the exterior object.

According to a fourth aspect of the present invention, a touch display device including a first substrate, a sensing electrode structure, a plurality of conductive electrode wires, an insulating protection layer, a shielding layer, a second substrate and a liquid crystal layer is disclosed. The first substrate, realized by a soft substrate, has a first surface and a second surface opposite to the first surface. The sensing electrode structure is disposed on the first surface for producing a first capacitance between the sensing electrode structure and an exterior object. The conductive electrode wires are disposed on the sensing electrode structure and located at edges of the sensing electrode structure. The insulating protection layer covers the conductive electrode wires and the sensing electrode structure. The shielding layer is disposed on the second surface, electrically connected to a ground side, and used for producing a second capacitance between the shielding layer and the sensing electrode structure when the exterior object presses the first substrate and causes the thickness of the first substrate to vary. The quantity of variation in the first and second capacitances is used for detecting a touch-control action of the exterior object. The second substrate is parallel to the first substrate and has an active pixel array. The liquid crystal layer is interposed between the first substrate and the second substrate.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A shows a touch panel according to a preferred embodiment of the invention.

FIG. 1B is a schematic view showing an outer surface of the touch panel of FIG. 1A having a protection structure.

FIG. 2 is a schematic view showing an outer surface of the touch panel of FIG. 1A having a protection structure.

FIG. 3 is a schematic view showing a touch display device according to a preferred embodiment of the invention.

FIGS. 4A and 4B respectively show a schematic view and a cross-sectional view of a touch panel according to another preferred embodiment of the invention.

FIG. 5 is a schematic view showing the action principle of the touch panel of FIG. 4A.

FIGS. 6A and 6B respectively show a schematic view and a cross-sectional view of a touch panel according to yet another preferred embodiment of the invention.

### DETAILED DESCRIPTION OF THE INVENTION

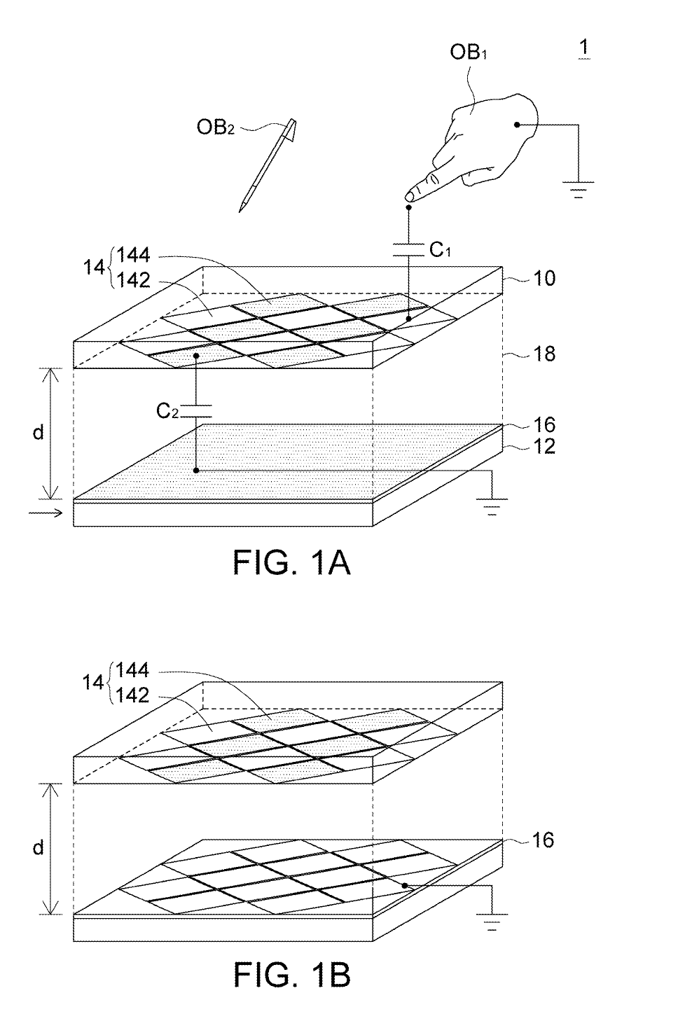

Referring to FIG. 1A, a touch panel according to a preferred embodiment of the invention is shown. As indicated in FIG. 1A, the touch panel 1 includes a first substrate 10, a second substrate 12, a sensing electrode structure 14 and a shielding layer 16. The first substrate 10 and the second substrate 12 are parallel to each other. The sensing electrode structure 14 is disposed on the first substrate 10. A first capacitance C₁ is produced between the sensing electrode structure 14 and an exterior object such as a finger OB₁ or a charged stylus OB₂. The shielding layer 16, being conductive, is disposed on the second substrate 12, electrically connected to a ground side, and used for producing a second capacitance C₂ between the sensing electrode structure 14 and the shielding layer 16 when the touch panel 1 is pressed and deformed. The quantity of variation in the second capacitance C₂ and the first capacitance C₁ is used for detecting a touch-control action of the exterior object.

The elements of the touch panel 1 of the present embodiment of the invention are disclosed below. Each of the first substrate 10 and the second substrate 12 is a transparent substrate made from glass, acrylic or resin. The flexibility of the structure of the first substrate 10 and the second substrate 12 enables the first substrate 10 and the second substrate 12 to be deformed when being pressed. In addition, the first substrate 10 and the second substrate 12 can be realized by a thin-film structure, so that the overall thickness of the touch panel 1 is effectively decreased and the deformation flexibility when being pressed is enhanced.

As indicated in FIG. 1A, the first substrate 10 and the second substrate 12 are separated by a soft spacer layer 18 which can be realized by an air layer or a flexible structure. For example, the gap between the first substrate 10 and the second substrate 12 can be filled with air or spread or coated with a transparent flexible material such as silicone oil and silica gel. The soft spacer layer 18 not only maintains a suitable gap d between the first substrate 10 and the second substrate 12 but also provides a space for the deformation of the first substrate 10 and the second substrate 12.

As indicated in FIG. 1A, the sensing electrode structure 14 and the shielding layer 16 are disposed face to face, but the present embodiment of the invention is not limited thereto. The sensing electrode structure 14 and the shielding layer 16 can also be disposed back to back or towards the same direction.

In practical application, the capacitor touch structure formed by the first substrate 10 and the sensing electrode structure 14 can be realized by a surface type capacitor structure, a projecting type capacitor structure or a capacitor structure of other types.

The present embodiment of the invention, the sensing electrode structure 14 includes a first electrode pattern layer 142 and a second electrode pattern layer 144. The first electrode pattern layer 142 and the second electrode pattern layer 144 are used for detecting a touch-control action on two coordinates perpendicular to each other such as the X coordinate and the Y coordinate of the position where the touch-control action occurs. The first electrode pattern layer 142 and the second electrode pattern layer 144 can be disposed on the same or different layers of the first substrate 10 (the intersection of two electrode pattern layers is separated by an insulating layer), or the first electrode pattern layer 142 and the second electrode pattern layer 144 can be disposed at two sides of the first substrate 10. In the diagrams of the above preferred embodiment, the electrode pattern is exemplified by diamond-shape, but such exemplification is not for limiting the present embodiment of the invention, and other shapes such square, oblong, and ellipse would also do.

In general, the capacitance increment induced by finger is 5 pF. In the present embodiment of the invention, given that the gap d between the first substrate 10 and the second substrate 12 is 50 μm and the hypotenuse of the diamond-shaped electrode pattern is 5 mm, when the deformation variation of the gap d is 20 μm, the capacitance increment caused by such deformation variation is about 5 pF, which is very close to the capacitance increment induced by the finger, and a touch environment similar to finger touch can thus be provided.

The shielding layer 16 and the sensing electrode structure 14 are made from a transparent conductive material, such as indium tin oxide (ITO). Preferably, the shielding layer 16 is realized by a structure with a particular pattern so as to increase the capacitance effect between the shielding layer 16 and the sensing electrode structure 14 and improve the sensitivity of touch detection. The shielding layer 16 of the present embodiment of the invention is in grounding state. Therefore, when external electrical noises enter the touch panel 1 from the outside of the second substrate 12, the shielding layer 16 isolates the incoming noises and such isolation function provides electromagnetic protection when the touch panel is assembled with other structures. The electromagnetic protection is elaborated in the disclosure below.

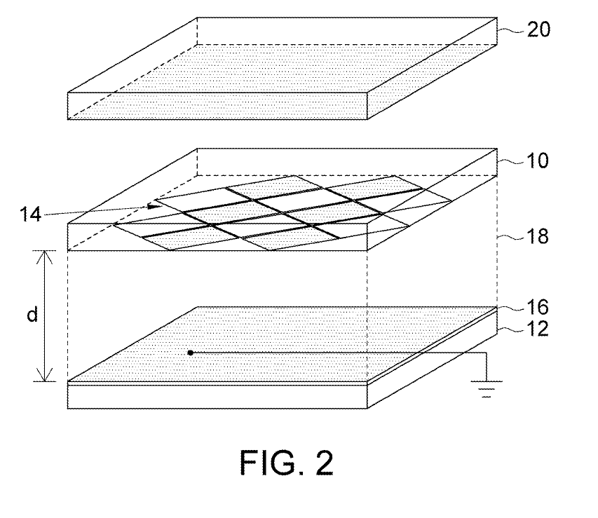

Referring to FIG. 2, a schematic view showing an outer surface of the touch panel of FIG. 1A having a protection structure is shown. As indicated in FIG. 2, the touch panel 1 further has a decorative coating 20, which is disposed (such as adhered) on an outer surface of the first substrate 10. Preferably, the decorative coating 20 and the sensing electrode structure 14 are disposed on different sides lest the decorative coating 20 might directly contact the electrode material. The decorative coating 20 is preferably made from a transparent flexible material. In addition to providing protection to the first substrate 10, when the first substrate 10 has a smaller thickness, the decorative coating 20 adhered on the first substrate 10 increases the thickness of the structure and effectively increases the deformation quantity of variation in the first substrate 10. Also, the decorative coating 20 can provide decorative pattern according to product design, and makes the appearance of the product even more attractive with smart design of colors, lines, color blocks and patterns.

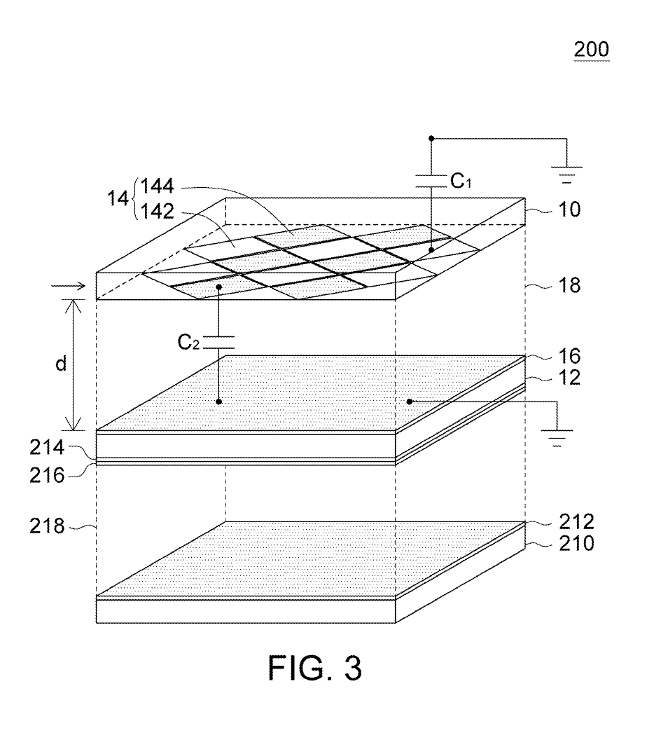

The touch panel 1 of the present embodiment of the invention can further be used in other devices. Referring to FIG. 3, a schematic view showing a touch display device according to a preferred embodiment of the invention is shown. As indicated in FIG. 3, apart from the first substrate 10, the second substrate 12, the sensing electrode structure 14, the shielding layer 16 and the soft spacer layer 18 that are already included in the touch panel 1 as disclosed above, the touch display device 200 further includes a third substrate 210 parallel to the second substrate 12. The third substrate 210 is substantially an active array substrate having an active pixel array structure 212. The active pixel array structure 212 includes a plurality of pixel switches (such as thin-film transistors) arranged in an array, signal lines (such as data lines and scan lines) and pixel electrodes for control the display of image pixels.

The second substrate 12 of the touch display device 200 is substantially a color filter substrate including a color filter structure 214 and a common electrode 216. Preferably, the shielding layer 16 and the common electrode 216 are disposed at two different sides of the second substrate 12. A liquid crystal layer 218 is interposed between the second substrate 12 and the third substrate 210, and the inclination of liquid crystal molecules is controlled by the active pixel array structure 212 and the common electrode 216.

The first substrate 10 of the touch display device 200 is substantially a cover lens, which can be directly formed on the cover lens with the sensing electrode structure 14. The cover lens is commonly made from a material with the features of high strength, scratching resistance, and high transparency such as glass, acrylics, and engineering plastics. For the first substrate 10 to have the feature of pressure resistance, the first substrate 10 cannot be too thick, and the thickness is normally smaller than 0.5 mm and is preferably 0.2 mm.

In addition to providing touch capacitance detection, the shielding layer 16 of the touch display device 200, being in grounding state, at the same time isolates the Vcom signal coming from the common electrode 216 of the second substrate 12 lest the signal of the touch panel might be interfered with by the Vcom signal.

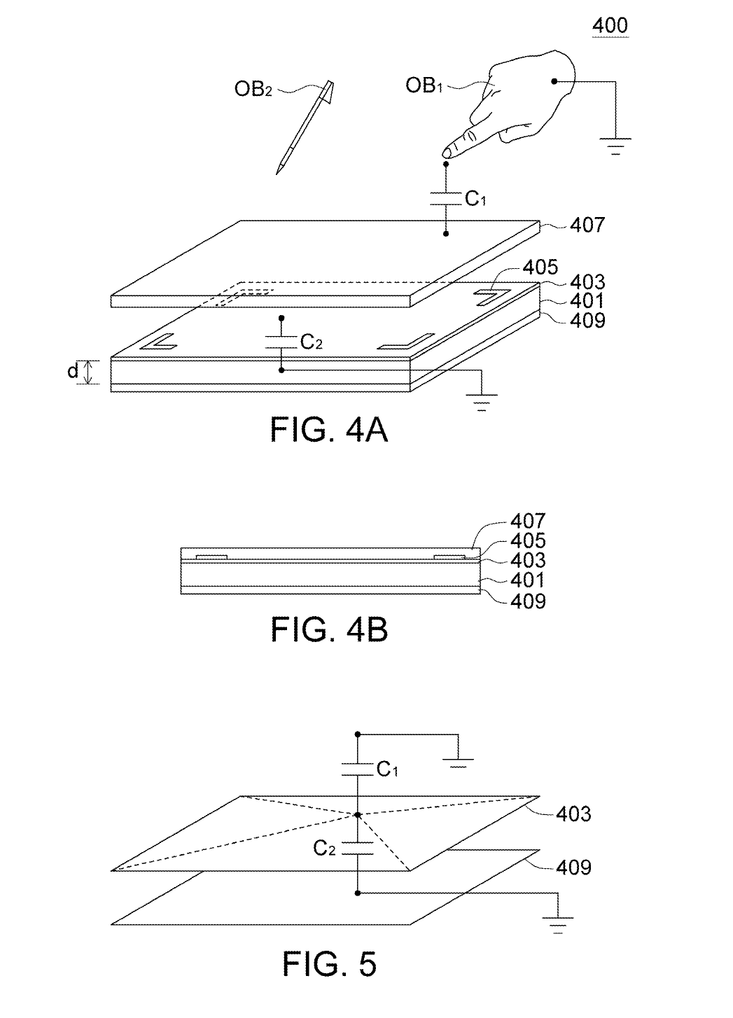

The present embodiment of the invention further discloses another touch panel structure. Referring to FIGS. 4A and 4B, a schematic view and a cross-sectional view of a touch panel according to another preferred embodiment of the invention are respectively shown. The touch panel 400 includes a soft substrate 401, a sensing electrode structure 403, a plurality of conductive electrode wires 405, an insulating protection layer 407 and a shielding layer 409. The soft substrate 401 has two opposite surfaces. The sensing electrode structure 403 is disposed on the top surface of the soft substrate 401 for producing a first capacitance C₁ between the sensing electrode structure 403 and the exterior object (such as the finger OB₁). The conductive electrode wires 405 are disposed on the sensing electrode structure 403, and located at edges of the sensing electrode structure 403. The insulating protection layer 407 covers the conductive electrode wires 405 and the sensing electrode structure 403. The shielding layer 409 is disposed on the bottom surface of the soft substrate 401, electrically connected to the ground side, and used for producing a second capacitance C₂ between the sensing electrode structure 403 and the shielding layer 409 when the exterior object presses the soft substrate 401 and causes the thickness of the soft substrate 401 to vary. The quantity of variation in the second capacitance C₂ and the first capacitance C₁ is used for detecting a touch-control action of the exterior object.

The sensing electrode structure 403 can be made from ITO and coated on the top surface of the soft substrate 401, then the conductive electrode wires 405 are manufactured. The conductive electrode wires 405 can be realized by silver electrode lines and located at four edge corners of the sensing electrode structure 403 by way of deposition process. The conductive electrode wires 405 can be further routed to the system side and used as signal input/output. Then, the insulating protection layer 407 is manufactured by deposition process. The shielding layer 409 can also be made from ITO and is routed to the system side to be grounded.

Referring to FIG. 5, a schematic view showing the action principle of the touch panel of FIG. 4A is shown. When the user touches or presses the panel, the electrical field of the human body and the sensing electrode structure 403 are coupled to produce the first capacitance C₁, and the second capacitance C₂ being variable is formed between the sensing electrode structure 403 and the shielding layer 409. Being driven by a high frequency current, the capacitor is equivalent to a direct conductor as expressed in the following formula:

$${X}_{C} = \frac{1}{2 π f ( {C}_{1} + {C}_{2} )}$$

In the formula, X_{c} denotes capacitive resistance, that is, when frequency changes, capacitance is converted to resistance. The higher the frequency f, the smaller the capacitive resistance, and the capacitor is equivalent to a short circuit. To the contrary, the lower the frequency f, the larger the capacitive resistance, and the capacitor is equivalent to an open circuit. Since the first capacitance C₁ and the second capacitance C₂ are connected in parallel, the total capacitance is: C₁+C₂. Thus, the larger the total capacitance, the smaller the capacitive resistance; the smaller the capacitive resistance, the larger the current. Thus, the touch position can be determined by measuring the ratio of the current flowing from the four corners.

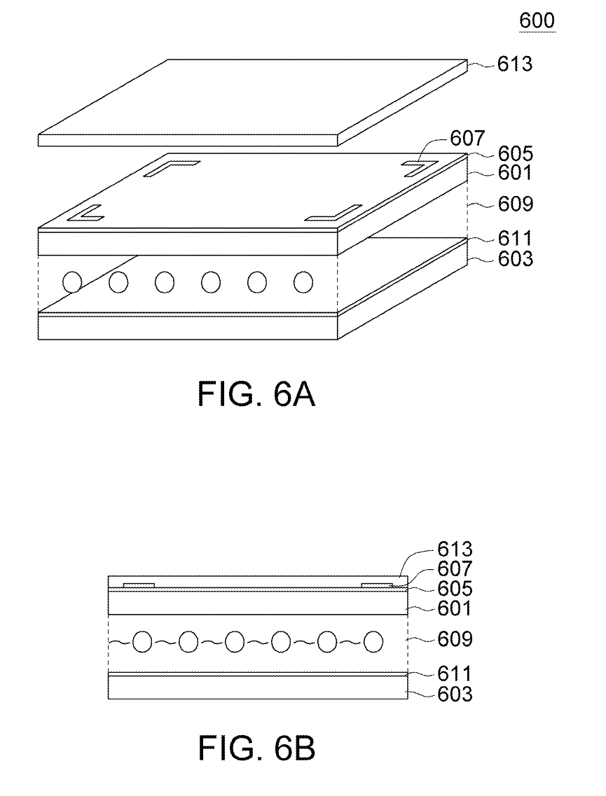

Referring to FIGS. 6A and 6B, a schematic view and a cross-sectional view of a touch panel according to yet another preferred embodiment of the invention are respectively shown. The touch panel 600 includes a first substrate 601, a second substrate 603, a sensing electrode structure 605, a plurality of conductive electrode wires 607, a soft spacer layer 609, a shielding layer 611 and an insulating protection layer 613. The first substrate 601 and the second substrate 603 are parallel to each other, and the soft spacer layer 609 is interposed between the first substrate 601 and the second substrate 603 for maintaining a gap between the first substrate 601 and the second substrate 603. The sensing electrode structure 605 is disposed on the first substrate 601. The conductive electrode wires 607 are disposed on the sensing electrode structure 605, and located at edges of the sensing electrode structure 605. The insulating protection layer 613 covers the conductive electrode wires 607 and the sensing electrode structure 605. A first capacitance is produced between the sensing electrode structure 605 and the exterior object. The shielding layer 611 is disposed on the second substrate 603, electrically connected to a ground side, and used for producing a second capacitance between the shielding layer 611 and the sensing electrode structure 605 when the exterior object is pressed and causes the gap to vary. The quantity of variation in the first and second capacitances is used for detecting a touch-control action of the exterior object.

The touch panel of FIG. 4A or FIG. 6A can form the touch display device of FIG. 2 when equipped with another substrate and elements such as liquid crystal layer.

According to the touch panel and the touch display device using the same disclosed in the above embodiments of the invention, a shielding layer, which is conductive and grounded, is interposed between two substrates of the touch panel so that the shielding layer forms a capacitance with the sensing electrode structure of the touch panel. The capacitance varies with the change of the gap between the two substrates, and is different from the inductive capacitor between the touch panel and an external charged object. Thus, the user can perform touch control with a finger or an insulating stylus. If the user has to wear gloves seasonally, the user can perform touch-control action by pressing without having to take off the gloves, making the operation more convenient and simple to the user.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel, comprising:
a first substrate;
a sensing electrode structure disposed on the first substrate for producing a first capacitance between the sensing electrode structure and an exterior object;
a second substrate parallel to the first substrate;
a soft spacer layer interposed between the first substrate and the second substrate for maintaining a gap between the first substrate and the second substrate; and
a shielding layer disposed on the second substrate, electrically connected to a ground side, and used for producing a second capacitance between the shielding layer and the sensing electrode structure when the exterior object is pressed and causes the gap to vary, wherein the quantity of variation in the first and second capacitances is used for detecting a touch-control action of the exterior object, wherein the shielding layer is made from a transparent conductive material.

2. The touch panel according to claim 1, wherein, the second capacitance further is used for detecting a pressure applied by the exterior object.

3. The touch panel according to claim 1, wherein, the sensing electrode structure and the shielding layer are disposed face to face.

4. The touch panel according to claim 1, wherein, the shielding layer has a pattern being the same or different with an electrode pattern of the sensing electrode structure.

5. The touch panel according to claim 1, further comprising:
a decorative coating disposed on one side of the first substrate opposite to the sensing electrode structure.

6. The touch panel according to claim 5, wherein, the material of the decorative coating comprises a transparent flexible material.

7. The touch panel according to claim 1, wherein, the soft spacer layer is an air layer or made from silicone oil or silica gel.

8. The touch panel according to claim 1, wherein, the sensing electrode structure comprises a first electrode pattern layer and a second electrode pattern layer, the quantity of variation in the first capacitance and the second capacitance together with the first electrode pattern layer and the second electrode pattern layer are used for detecting a coordinate position of the touch-control action in two mutually perpendicular directions.

9. The touch panel according to claim 8, wherein, the first electrode pattern layer and the second electrode pattern layer are coplanar, disposed on different layers at the same side of the first substrate or disposed on surfaces at two opposite sides of the first substrate.

10. The touch panel according to claim 1, wherein, at least one of the first substrate and the second substrate is a transparent thin-film.

11. The touch panel according to claim 1, further comprising:
a plurality of conductive electrode wires disposed on the sensing electrode structure and located at a plurality of edges of the sensing electrode structure; and
an insulating protection layer covering the conductive electrode wires and the sensing electrode structure.

12. A touch panel, comprising:
a soft substrate having a first surface and a second surface opposite to the first surface;
a sensing electrode structure disposed on the first surface for producing a first capacitance between the sensing electrode structure and an exterior object;
a plurality of conductive electrode wires disposed on the sensing electrode structure and located at a plurality of edges of the sensing electrode structure;
an insulating protection layer covering the conductive electrode wires and the sensing electrode structure; and
a shielding layer disposed on the second surface, electrically connected to a ground side, and used for producing a second capacitance between the shielding layer and the sensing electrode structure when the exterior object presses the soft substrate and causes the thickness of the soft substrate to vary, wherein the quantity of variation in the first and second capacitances is used for detecting a touch-control action of the exterior object, the shielding layer is made from a transparent conductive material.

13. The touch panel according to claim 12, wherein, the second capacitance further is used for detecting a pressure applied by the exterior object.

14. A touch display device, comprising:
a first substrate;
a sensing electrode structure disposed on the first substrate for producing a first capacitance between the sensing electrode structure and an exterior object;
a second substrate parallel to the first substrate;
a soft spacer layer interposed between the first substrate and the second substrate for maintaining a gap between the first substrate and the second substrate;
a shielding layer disposed on the second substrate, electrically connected to a ground side, and used for producing a second capacitance between the shielding layer and the sensing electrode structure when the exterior object is pressed and causes the gap to vary, wherein the quantity of variation in the first and second capacitances is used for detecting a touch-control action, the shielding layer is made from a transparent conductive material;
a third substrate parallel to the second substrate and having an active pixel array structure; and
a liquid crystal layer interposed between the second substrate and the third substrate.

15. The touch display device according to claim 14, wherein, the second capacitance further is used for detecting a pressure applied by the exterior object.

16. The touch display device according to claim 14, wherein, the second substrate has a common electrode, and the shielding layer is interposed between the common electrode and the sensing electrode structure.

17. The touch display device according to claim 16, wherein, the second substrate further has a color filter structure disposed at the same side of the second substrate with the common electrode.

18. The touch display device according to claim 14, wherein, the sensing electrode structure and the shielding layer are disposed face to face.

19. The touch display device according to claim 14, wherein, the shielding layer has a pattern being the same or different with an electrode pattern of the sensing electrode structure.

20. The touch display device according to claim 14, wherein, the soft spacer layer is an air layer or made from silicone oil or silica gel.

21. The touch display device according to claim 14, wherein, the sensing electrode structure comprises a first electrode pattern layer and a second electrode pattern layer, the quantity of variation in the first capacitance and the second capacitance together with the first electrode pattern layer and the second electrode pattern layer are used for detecting a coordinate position of the touch-control action in two mutually perpendicular directions.

22. The touch display device according to claim 21, wherein, the first electrode pattern layer and the second electrode pattern layer are coplanar, disposed on different layers at the same side of the first substrate or disposed on surfaces at two opposite sides of the first substrate

23. The touch display device according to claim 14, further comprising:
a plurality of conductive electrode wires disposed on the sensing electrode structure, and located at a plurality of edges of the sensing electrode structure; and
an insulating protection layer covering the conductive electrode wires and the sensing electrode structure.

24. A touch display device, comprising:
a first substrate being a soft substrate and having a first surface and a second surface opposite to the first surface;
a sensing electrode structure disposed on the first surface for producing a first capacitance between the sensing electrode structure and an exterior object;
a plurality of conductive electrode wires disposed on the sensing electrode structure, and located at a plurality of edges of the sensing electrode structure;
an insulating protection layer covering the conductive electrode wires and the sensing electrode structure;
a shielding layer disposed on the second surface, electrically connected to a ground side, and used for producing a second capacitance between the shielding layer and the sensing electrode structure when the exterior object presses the first substrate and causes the thickness of the first substrate to vary, wherein the quantity of variation in the first and second capacitances is used for detecting a touch-control action of the exterior object;
a second substrate parallel to the first substrate and having an active pixel array; and
a liquid crystal layer interposed between the first substrate and the second substrate.
